(19) United States
(12) Patent Application Publication
(10) Pub. No.: US 2005/0262756 A1
(43) Pub. Date: Dec. 1, 2005

(54) Portable vapor bee smoker

(76) Inventor: Paul P. Younger, Queen Creek, AZ (US)

Correspondence Address: ROBERT A. PARSONS, 4000 N. CENTRAL AVENUE, SUITE 1220, PHOENIX, AZ, 85012, US

(21) Appl. No.: 11/185,407

(22) Filed: Jul. 20, 2005

Related U.S. Application Data
(62) Division of application No. 10/358,825, filed on Feb. 5, 2003.
(60) Provisional application No. 60/408,119, filed on Sep. 3, 2002.

(51) Int. Cl. A01K 55/00

(52) U.S. Cl. 43/128

(57) ABSTRACT

A portable vapor bee smoker including a housing, a reservoir carried by the housing, vapor fluid containing liquid smoke carried by the reservoir, a vapor generator carried by the housing and coupled to the reservoir for receiving the vapor fluid, and a heat source carried by the housing for heating the vapor generator for turning the vapor fluid into a vapor.

### CROSS-REFERENCE TO RELATED APPLICATION

This application claims the benefit of U.S. Provisional Application No. 60/408,119 filed 3 Sep. 2002.

### FIELD OF THE INVENTION

This invention relates to smoke simulating devices.

In a further and more specific aspect, the instant invention concerns smoke simulating machines for use by bee keepers.

### BACKGROUND OF THE INVENTION

Devices for creating smoke have long been employed in the bee industry. Smoke is used to control bees during manipulation of hives for the production and collection of honey. Smokers are also used in the movement of swarms, for pollination purposes or to remove unwanted or dangerous swarms. A conventional smoker is a simple device that has been in use, and remained substantially unchanged, for hundreds of years. It typically includes a can or body having a lid, a handle and a spout. A fire is built in the body to generate smoke. The materials used for the fire can be substantially anything that burns and will produce smoke. The smoke exits the device through the spout and can be directed as desired. A pump or bellows can be included to stoke the fire, and forcefully eject the smoke.

While obviously effective, as they have been used for many years, smokers are prone to many problems and safety hazards. To be available for use, a smoker must have a fire burning at all times. Thus, if the fire goes out, the smoker will be unusable if needed. With a fire burning for extended periods of time, the smoker itself will become hot and can injure the user or damage property. Additionally, the smoker can be knocked over and possibly start fires.

It would be highly advantageous, therefore, to remedy the foregoing and other deficiencies inherent in the prior art.

Accordingly, it is an object of the present invention to provide a new and improved bee smoker.

Another object of the invention is to provide a bee smoker which employs a vapor as a smoke substitute.

And another object of the invention is to provide a bee smoker which is easily maintained and used.

Still another object of the present invention is to provide a bee smoker which is safe to use.

### SUMMARY OF THE INVENTION

Briefly, to achieve the desired objects of the instant invention in accordance with a preferred embodiment thereof, provided is a bee smoker for controlling bees. The bee smoker includes a housing, a reservoir carried by the housing, a vapor generator carried by the housing and coupled to the reservoir, and a heat source carried by the housing for heating the vapor generator. A fluid from the reservoir can be transferred to the vapor generator by gravity feed or a pump mechanism. In a specific embodiment, the vapor fluid includes a vapor forming material such as glycol and liquid smoke or smoke extract. In another aspect of the invention, the vapor generator includes metal tubing wound into a coil having an inlet coupled to the reservoir and an outlet.

### BRIEF DESCRIPTION OF THE DRAWINGS

The foregoing and further and more specific objects and advantages of the instant invention will become readily apparent to those skilled in the art from the following detailed description of a preferred embodiment thereof taken in conjunction with the drawings, in which:

FIG. 1 is a perspective view illustrating a portable vapor bee smoker as used on a hive, according to the present invention;

FIG. 2 is a sectional side view of the portable vapor bee smoker of FIG. 1, with portions of the housing removed; and

FIG. 3 is an end view of the portable vapor bee smoker FIG. 2.

FIG. 4 is a side view of the working components of the smoker with the housing removed;

FIG. 5 is a side view of another embodiment of the working components of the smoker with the housing removed;

FIG. 6 is an enlarged perspective view of the vapor generator according to the present invention; and

FIG. 7 is an enlarged perspective view of an electrical heating source for use in the bee smoker.

### DETAILED DESCRIPTION OF THE PREFERRED EMBODIMENT

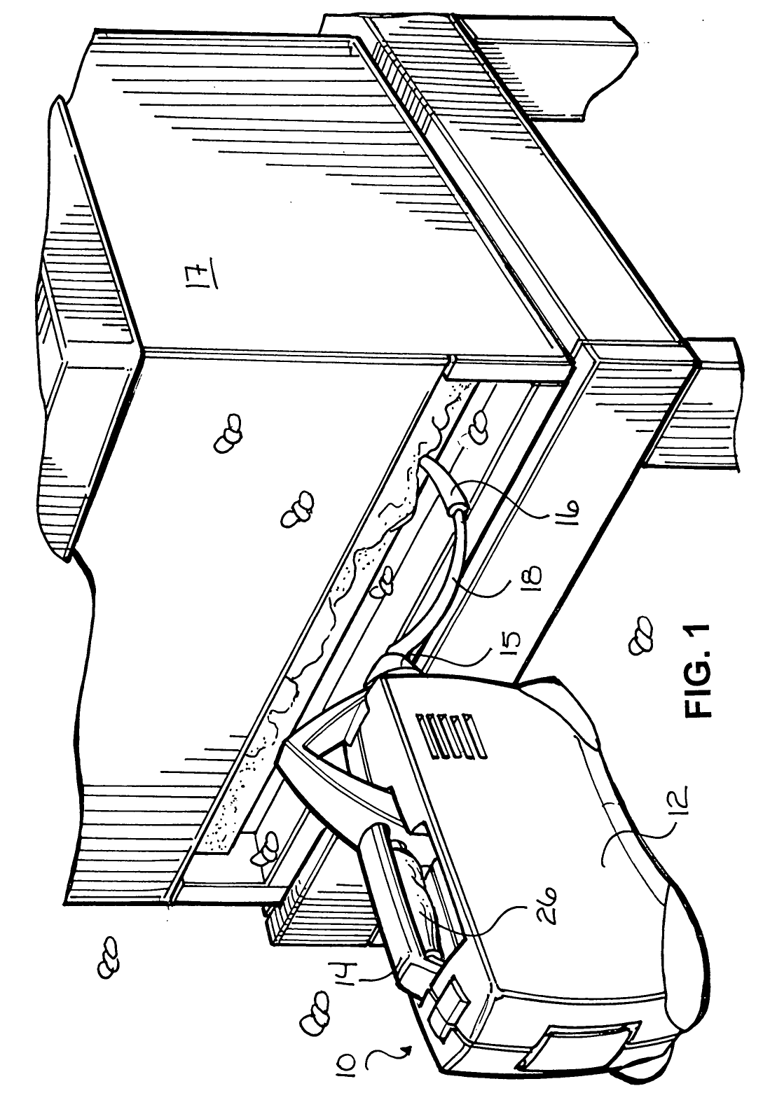

Turning now to the drawings in which like reference characters indicate corresponding elements throughout the several views, attention is first directed to FIG. 1 which illustrates a portable vapor bee smoker, generally designated 10. Bee smoker 10 includes a housing 12 having a handle 14 for ease in carrying and manipulating. Housing 12 is preferably formed of a high impact plastic material, but can also be fabricated of substantially any other rigid material such as metal, plastic, wood, etc. Housing 12, in this embodiment, can be opened to access the inner working components which will be described presently. With additional reference to FIG. 3, an aperture 15 is formed in housing 12 to allow vapor smoke to escape, or accommodate a nozzle 16. Bee smoker 10 is used in a manner similar to conventional bee smokers to control bees around a hive 17. Smoke is used to stun or stupefy bees allowing the manipulation of the hive, honey combs within the hive, or entire swarms of bees for relocation etc. To facilitate injection of vapor smoke into hive 17, a nozzle extension 18 can be employed. One skilled in the art will understand that an aperture may be employed alone or nozzle 16 may be employed without an extension as desired and for facilitating different uses.

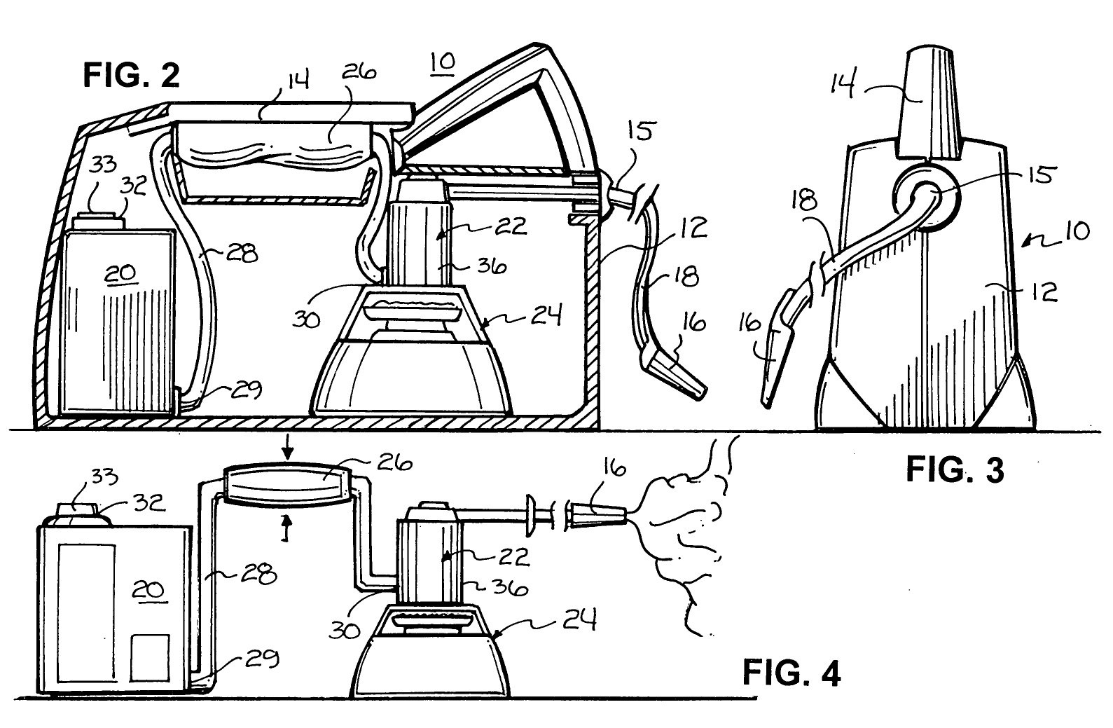

Turning now to FIGS. 2 and 4, the inner working components of bee smoker 10 are illustrated. Within housing 12 is carried a reservoir 20 for holding a vapor fluid, a vapor generator 22 for converting the vapor fluid to a vapor, a heat source 24 for heating the vapor fluid within vapor generator 22, and a pump mechanism 26 for moving the fluid from reservoir 20 into vapor generator 22. A conduit 28, such as plastic tubing, extends from an outlet 29 of reservoir 20, to an inlet 30 of vapor generator 22. Reservoir 20 is preferably formed of a durable non-porous material such as plastic or metal, and includes a fill opening 32 through which the vapor fluid can be poured. Opening 32 is closed by a cap 33 and is located on the top of reservoir 20. Outlet 29 is located proximate a bottom of reservoir 20 to facilitate draining thereof. Pump mechanism 26 can be employed to transfer vapor fluid from reservoir 20 through conduit 28 to vapor generator 22. While many types of pumps can be used, such as electric pumps and the like, in this preferred embodiment, a hand operated pump is used.

With additional reference back to FIG. 1, pump mechanism 26 is a primer bulb such as that used in gas cans for outboard motors and the like. In this instance, a primer bulb can be positioned in conduit 28 intermediate reservoir 20 and vapor generator 22. The primer bulb is positioned adjacent and under handle 14 to permit a user to grasp handle 14 and the primer bulb in one hand. The amount of vapor generated can be controlled by the amount of fluid transferred to vapor generator 22. Compression of the primer bulb, to a greater or lesser extent, regulates the amount of vapor fluid transferred to the vapor generator. A check valve and an on/off valve can be added to conduit 28. The check valve prevents backflow of the vapor fluid, while the on/off valve will prevent leakage when smoker 10 is not being used. The valve would be turned to the open or on position prior to use to allow flow of the smoke fluid from reservoir 20 to vapor generator 22.

With additional reference to FIG. 6, vapor generator 22 includes metal tubing 30 wound into a coil having an inlet 32 positioned at the base thereof and coupled to reservoir 20 by conduit 28 and an outlet 34 positioned at the top of the coil. The coil can be carried within a metal container 36 to aid in heat conservation and equal dispersion. Metal tubing 30 is preferably 3/8 inch copper tubing wound tightly into a coil of approximately 3/4 inches in diameter and 4 inches high. Container 36 is preferably a portion of copper piping 1½ inches in diameter and 4 inches in depth to accommodate the coiled copper tubing. In operation, vapor fluid enters inlet 32 of metal tubing 30 is heated by heating source 24 and expands moving up the coil to exit as a vapor from outlet 34.

Heat source 24 can be a variety of different devices such as those that use liquid fuel, gas fuel or electricity. In this embodiment, vapor generator 22 is mounted on a small gas stove similar to those used for camping. However, it should be understood that any device such as a propane torch can be utilized, with the heating element or burner located proximate the base of the coil. With momentary reference to FIG. 7, an electric heating element 40 can be employed, powered by battery 42, or other power source. In this instance, heating element 40 can fit up into the coil, contacting metal tubing 30 to transfer heat. Outlet 34 can terminate proximate or extend from aperture 15 of housing 12. If desired, nozzle 16 can be attached to metal tubing 30 at outlet 34 to focus and direct the exiting vapor.

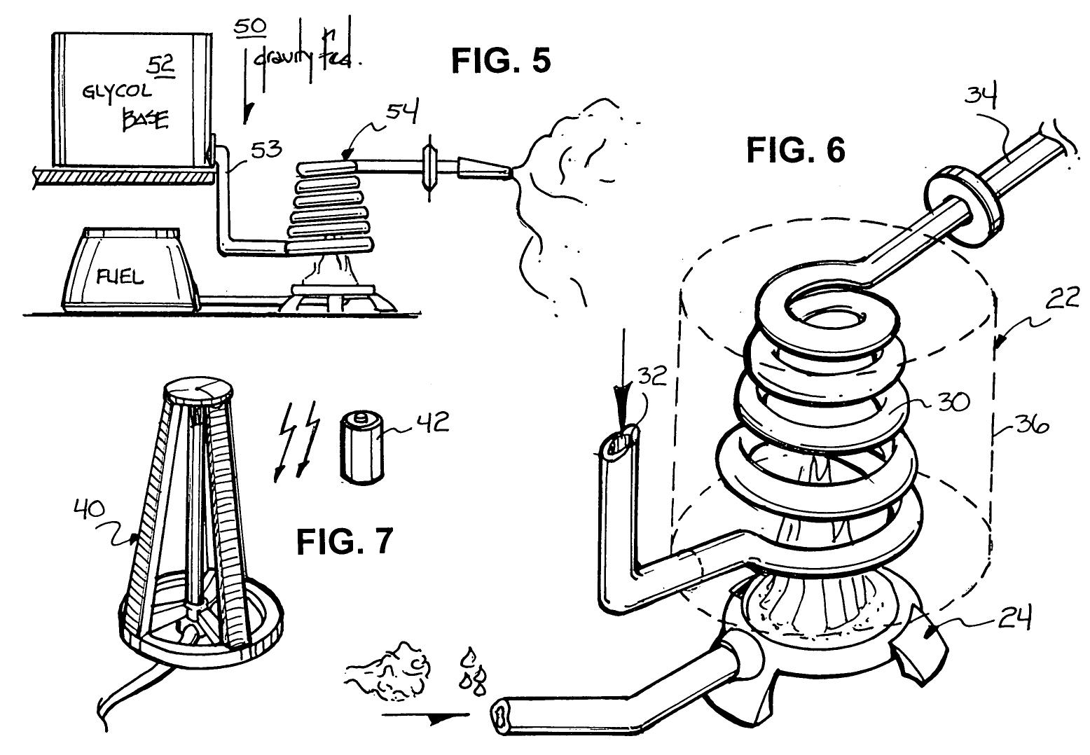

Referring now to FIG. 5, another embodiment of the inner working components, generally designated 50, are illustrated. In this embodiment components 50 are arranged in a gravity feed configuration, in which a pump mechanism is not utilized to transfer vapor fluid. Instead, while the components are substantially identical, including a reservoir 52 coupled by a conduit 53 to a vapor generator 54, reservoir 52 is positioned above vapor generator 54. As the vapor fluid is converted to a vapor and exits vapor generator 54, replacement fluid enter vapor generator 54.

The vapor fluid itself is a very important portion of bee smoker 10. Ordinary vapor, will not be effective in controlling bees. To provide bee controlling characteristics, an essential ingredient to the vapor fluid is liquid smoke (smoke extract), similar to the type employed in cooking and widely available in the market. To provide a vapor that remains stable for a sufficient period of time, the liquid smoke is mixed with glycol, triethylene glycol, glycerine or the like. Water can be added to produce a vapor which dissipates more quickly. As the concentration of water is increased, the vapor produced dissipates more quickly. While the concentration of liquid smoke can vary, it has been found that at approximately 18 percent liquid smoke works most effectively.

Various changes and modifications to the embodiments herein chosen for purposes of illustration will readily occur to those skilled in the art. To the extent that such modifications and variations do not depart from the spirit of the invention, they are intended to be included within the scope thereof which is assessed only by a fair interpretation of the following claims.

Having fully described the invention in such clear and concise terms as to enable those skilled in the art to understand and practice the same, the invention claimed is:

1. A portable smoke generator comprising:
a housing having a handle;
a reservoir carried by the housing;
a vapor generator carried by the housing and coupled to the reservoir; and
a heat source carried by the housing for heating the vapor generator.

2. A portable smoke generator as claimed in claim 1 further including a pump coupled to the reservoir for supplying a fluid from the reservoir to the vapor generator.

3. A portable smoke generator as claimed in claim 2 further including a conduit coupling an outlet of the reservoir to an inlet of the vapor generator.

4. A portable smoke generator as claimed in claim 3 wherein the pump includes a primer bulb coupled to the conduit.

5. A portable smoke generator as claimed in claim 1 wherein the vapor generator includes metal tubing wound into a coil having an inlet coupled to the reservoir and an outlet.

6. A portable smoke generator as claimed in claim 5 wherein the heat source includes one of a gas burner and an electric burner.

7. A portable smoke generator as claimed in claim 2 wherein the housing includes a handle and the pump is a hand actuated pump carried by the handle.

8. A portable smoke generator as claimed in claim 5 wherein the housing includes a spout coupled the outlet of the vapor generator.

9. A portable vapor bee smoker comprising:
a housing;
a reservoir carried by the housing;
vapor fluid containing liquid smoke carried by the reservoir;
a vapor generator carried by the housing and coupled to the reservoir for receiving the vapor fluid; and
a heat source carried by the housing for heating the vapor generator for turning the vapor fluid into a vapor.

10. A bee smoker as claimed in claim 9 wherein the vapor fluid further includes one of glycol, triethylene glycol, and glycerine.

11. A bee smoker as claimed in claim 10 further including a pump coupled to the reservoir for supplying the vapor fluid from the reservoir to the vapor generator.

12. A bee smoker as claimed in claim 11 further including a conduit coupling an outlet of the reservoir to an inlet of the vapor generator.

13. A bee smoker as claimed in claim 12 wherein the pump includes a primer bulb coupled to the conduit.

14. A bee smoker as claimed in claim 10 wherein the vapor generator includes metal tubing wound into a coil having an inlet coupled to the reservoir and an outlet.

15. A bee smoker as claimed in claim 10 wherein the heat source includes one of a gas burner and an electric burner.

16. A bee smoker as claimed in claim 10 wherein the housing includes a handle and the pump is a hand actuated pump carried by the handle.

17. A bee smoker as claimed in claim 14 wherein the housing includes a spout coupled the outlet of the vapor generator.

18. (canceled)

19. (canceled)

20. (canceled)

21. A method of controlling bees comprising the steps of:
providing a bee smoker including a housing, a reservoir carried by the housing, a vapor generator carried by the housing and coupled to the reservoir, and a heat source carried by the housing;
adding a vapor fluid containing liquid smoke to the reservoir; and
heating the vapor generator with the heat source thereby turning the vapor fluid into a vapor.

22. A method as claimed in claim 21 further including the step of:
providing a conduit coupling an outlet of the reservoir to an inlet of the vapor generator and a primer bulb coupled to the conduit; and
pumping the fluid vapor from the reservoir to the vapor generator by manually squeezing the primer bulb.
